(19) United States
(12) Patent Application Publication
(10) Pub. No.: US 2015/0330471 A1
(43) Pub. Date: Nov. 19, 2015

(54) DEVICE AND METHOD FOR PRODUCING A SPRING MADE OF FIBER COMPOSITE MATERIAL

(71) Applicant: LEICHTBAU-ZENTRUM SACHSEN GMBH, Dresden (DE)

(72) Inventors: Werner HUFENBACH, Dresden (DE); Martin LEPPER, Dresden (DE); Jens WERNER, Coswig (DE); Christian KOEHLER, Dresden (DE); André BARTSCH, Dresden (DE)

(21) Appl. No.: 14/652,284

(22) PCT Filed: Dec. 6, 2013
(86) PCT No.: PCT/DE2013/100410

§ 371 Date: Jun. 15, 2015

(30) Foreign Application Priority Data
Dec. 21, 2012 (DE) 10 2012 112 937.1

(51) Int. Cl. F16F 1/02; F16F 1/04; F16F 1/366; B29C 53/12

(52) U.S. Cl. CPC F16F 1/021; B29C 53/12; F16F 1/024; F16F 1/04; F16F 1/366; F16F 1/3665; B29L 2031/774

(57) ABSTRACT

The invention relates to a method for producing a spring made of fiber composite material, in which a laminate strand which is formed from fibers of fiber composite material and is impregnated with a matrix material that can be consolidated is reshaped into a spring geometry. The invention also relates to a device for carrying out the method. On the method side, it is proposed that, prior to reshaping the laminate strand (2), a strand-shaped pre-product (20) is formed by applying a deformable protective jacket (16), which encloses the laminate strand (2), in a continuous application process. On the device side, it is proposed that an application unit (15) for forming a protective jacket (16) around the laminate strand (2) is arranged downstream of the processing device (1) in the transport direction of the laminate strand (2).

The invention relates to a method for producing a spring made of fiber composite material in which a laminate strand, formed from fibers of the fiber composite material and impregnated with a matrix material capable of consolidation, is formed into a spring geometry.

The invention also relates to a device for performing the method, in particular for the production of a spring made of fiber composite material with machining equipment to produce a laminate strand formed of fibers and impregnated with a matrix material capable of consolidation.

In addition, the invention relates to a spring made of fiber composite material.

Devices and processes for producing springs made of fiber composite material are generally known. For example, springs produced in this manner are used in the automotive industry.

For purposes of the production of the springs described here, for example, fibers/rovings impregnated with matrix material are continually twisted or wound around a flexible, strand-shaped spring core or hollow section in order to form a fiber strand.

Such a method is known from DE 10 2011 018 217 A1. During the winding process, the fibers are impregnated multiple times with a resin whilst being wound around the spring core, whereby a wet, strand-shaped laminate is created and the strand-shaped laminate is thereafter wound around a forming tool with a spiral groove conforming to the geometry and size of the spring. This subsequent production step is subject to the application of heat to the forming tool until the spring has cured.

A significant disadvantage of the method described above is that drops from the laminate/roving strand heavily soil both the production device itself as well as the forming tool.

In particular, soiling of the spiral grooves within the forming tools result in adhesion of the laminate strand to the forming tool and to larger, undesired tolerance values. In addition, this results in increased cleaning work that, even following short production cycles, results in lengthy downtime and thus precludes production continuity.

Using the prior art described above as the starting point, the object of the invention is to create a method and a device for the production of a spring made of a fiber composite material that overcomes the disadvantages of the prior art and in particular improves the production process such that higher production rates are achieved.

Furthermore, the object of the invention is to improve the quality and range of applications for a spring made of fiber composite material.

The object is accomplished according to the invention via a process based on the principles described in claim 1; beneficial features of the invention are described in dependent claims 2 to 13.

Furthermore, the object is accomplished according to the invention by a device for implementing the process according to the features described in claims 14 to 20.

The object related to improvements to the spring is accomplished by a spring according to claims 21 to 23.

With regard to the process, the invention presumes that in a step preliminary to production a spring of fiber composite material is produced using a laminate strand impregnated with a matrix material that may be consolidated.

According to the invention, a strand-shaped precursor is created prior to reshaping a laminate strand created in this manner to fit the spring geometry by applying a moldable protective coat enclosing the laminate strand via a continual application process.

Application of the moldable protective coat to the laminate strand improves the subsequent molding process compared to the prior processes. The laminate strand impregnated with matrix material is completely encased and thus is provided a sealed, smooth and dry surface.

The encased laminate strand comprises a strand-shaped precursor by means of which the previously-criticized soiling of the equipment components in the subsequent processes and the forming tools is avoided and which enables adhesion-free, dry additional processing or interim storage.

In particular, the molding process is no longer impaired by contamination, whereby the continual use of the molding tools is possible without interruptions for cleaning.

Pursuant to an advantageous embodiment of the method, a continuous application process is provided for that creates a protective coat around the laminate strand by extruding a molten mass of plastic or metal and continuously pouring such mass around the laminate strand. The method enables a continuous coating process for the production of a uniform protective coat around the laminate strand. The result of the continuous, extensive pouring of the extruded molten mass around the laminate strand is to create a protective coat the completely encloses the laminate strand with a homogeneous surface. For example, the extruded molten mass may be uniformly spread over the surface of the laminate strand by means a casting mold that encloses and passes through the laminate strand.

Pursuant to an advantageous embodiment of the method, the plastic used is a thermoplastic or a wax. This creates a malleable, dimensionally stable protective coat over the laminate strand. The malleable, dimensionally stable protective coat has the advantage that the strand-shaped preliminary product created in this manner behaves in an inherently stable manner on the molding tool during the molding process to create the respective spring geometry and hardly needs to be set. As a result, the molding tools for the molding process to mold the preliminary product into the respective spring geometry do not require extensive guide grooves or slots. The winding process to shape the preliminary product into the spring geometry may be performed using a smooth tool, whereby the shape retains a high degree of dimensional accuracy without the necessity of significant re-working.

Due to the malleable characteristics of the protective coat, the shaped preliminary product may, directly following the winding process, be removed from the molding tool prior to consolidation (curing) and may be further processed in a separate curing or tempering oven. This simplifies and accelerates the molding process, increases the utilisation of the molding tools and improves the production cycle. In addition, the ability to forego guide grooves on the molding tool reduces the costs for the production of the molding tool significantly.

The protective coat may be colored through the use of plastics of different colors, whereby for example the ability to recognise or differentiate, respectively, different laminate strands may be created.

An alloy with a low melting point, for example, bismuth, is provided for as an alternative metal for the protective coat in lieu of plastic.

This material likewise creates a malleable protective coat characterised by light-weight and permanent moldability with the advantages described above when further processing the preliminary product.

Pursuant to an advantageous, alternative embodiment of this method, a continuous application process is provided for in which the protective coat is created by means of the continuous encasing of the laminate strand and sealing with a strip material of plastic or metal.

For example, a strip material of metal may be molded by means of the continuous draw bending of thin metal sheets that is thus adjusted to fit the cross-sectional geometry of the laminate strand and may be directly molded to it.

The strip material thus molded around the laminate strand is thereafter sealed along its edges meeting in the longitudinal direction of the laminate strand. The sealing of the strip material of metal may for example be accomplished via welding or via a laser welding device or by means of soldering, whereby a high degree of stability may be achieved on the one hand and a high degree of density for the protective coat on the other.

The result is likewise the creation of an advantageous, strand-shaped preliminary product with a malleable protective coat with a closed, smooth and dry surface for further processing.

The preferred strip material comprises an easily moldable and malleable material such as thin aluminum, steel or titanium sheets, with which a malleable and dimensionally stable protective coat is created with the advantages described above for further processing of the preliminary product.

In light of the particular dimensional stability of a malleable protective coat created in this manner, the preliminary product is especially suited for cold forming via a space and cost-saving form element for free-form spring winding.

The stand-shaped preliminary product created by means of the steps described above is cut into sections with a defined length following the advantageous continuation of the process and the ends of the composite sections are sealed with the protective coat.

Sealing the ends prevents liquid matrix material from leaking from the cut surfaces of the strand sections.

A preliminary product is created that is strand-shaped and enclosed on all sides that is easy to manipulate and space-saving, for example stackable on a pallet, on a shelf or similar storage facility and is thus suited to interim storage for later use.

According to an advantageous embodiment of the method, the intent is to dip the ends of the strand sections into a molten mass in order to create a protective cap that is preferably comprised of plastic. This immersion process enables fast and reliable sealing of the strand-shaped preliminary products.

Alternatively, the ends of the strand segments may be sealed by placing pre-fabricated, perfectly fitting protective caps that are preferably comprised of plastic.

Sealing or enclosure, respectively, of the ends of the strand sections, in particular with protective caps, pursuant to the embodiments described above is particularly suited, not only to seal the cut surfaces, but also to enclose the fiber ends and the edges of the protective coat of the preliminary product and thus improve sealing performance.

Pursuant to an additional embodiment of the method, the intent is to have the protective coat and/or protective caps remain a component of the springs following molding of the preliminary product and consolidation of the matrix material.

The benefit of this embodiment is that the spring formed in this manner is protected against wear and tear, chipping, other mechanical and chemical stresses as well as weather-related effects. The spring is thus particularly suited for use in all-terrain vehicles.

Alternatively to the embodiment described above, the intent is to remove the protective coat and/or protective caps from the spring following molding of the preliminary product and consolidation of the matrix material. The protective coat may for example be removed mechanically by cutting and peeling or thermally by melting the respective material.

If the protective coat is removed, the mass or weight, respectively, is reduced without a loss of the damping effect of the spring which makes the spring particularly suited for use in light-weight vehicles such as sports cars.

Pursuant to an additional embodiment of the method, the intent is form the laminate strand on a strand-shaped, malleable core element.

The malleability and shape retention of the laminate strand are improved for purposes of further processing through the use of a malleable core element. In addition, the selective choice of the malleable core element as to form, size and material may have a variable and favourable influence on the quality of the preliminary product during processing and on the quality of the finished springs. If the strand-shaped, malleable core element is intended as an auxiliary core and is comprises of a meltable material, the core element may be removed from the spring following curing resulting in an additional reduction in weight without a loss of the damping effect.

Pursuant to an advantageous embodiment of the method, the intent is to create a strand-shaped, malleable core element of a thermoplastic plastic, titanium or aluminum. By means of creating the core element from one of the materials described above, the core element will be created in a moldable and dimensionally stable manner. The result is to provide support to the plastic malleability of the preliminary product and dimensionally stable winding for the spring form of the preliminary product on the molding tool.

The embodiment of the invention provides for a device for carrying out the method that is downstream from the processing equipment in the direction of travel of the laminate strand and comprises an application unit for the creation of a protective coat around the laminate strand.

According to an advantageous embodiment of the device, the application unit comprises an extruder with a molding matrix that encloses the laminate strand in order to continuously extrude and cast a molten mass.

Pursuant to an advantageous, alternate embodiment of the method of the device, the application unit comprises a molding tool with a molding matrix that encompasses the laminate strand for purposes of continuously applying a strip material and a joining device for the continuous closure of the strip material.

A preferred further development of the device comprises a supplemental device for the creation of strand sections of the strand-shaped preliminary product that is downstream from the application unit in the direction of travel of the laminate strand.

A practical embodiment of the device includes a sealing device to seal the ends of the strand sections comprised preferably of a plunge basin with a molten mass.

A cost-saving embodiment of the device provides for a molding tool for purposes of molding the strand-shaped preliminary product into the spring geometry with a smooth-walled winding core to which a, preferably heatable, guide element is attached.

Alternatively, a space and cost-saving embodiment of the device provides for a molding tool with a, preferably heatable, guide element for purposes of freely winding the strand-shaped preliminary product into the spring geometry.

According to the invention there is provided a spring, whereby the spring evidences a strand-shaped core element molded in the shape of the spring geometry of the spring, whereby such core element is encompassed by a fiber layer of fiber composite encompassing, whereby a protective coat encompasses the fiber layer, whereby the ends of the springs have protective caps.

The invention further provides a spring, whereby the spring evidences an elongated hollow section strand made of a fiber layer composed of fiber composite material molded into the spring geometry of the spring, whereby the hollow section strand is encompassed by a protective coat, whereby the ends have protective caps.

Pursuant to an advanced embodiment of the spring embodying the invention, the protective coat, the strand-shaped core element, the hollow section strand and/or protective caps are made of plastic or metal.

The spring embodying the invention in the alternative embodiments described above is characterised by a low mass, a high degree of wear resistance and strength in particular in addition to the advantages described above.

The manufacturing process according to the invention in combination with the associated device for carrying out the process afford a number of advantages compared the prior art, in particular characterized by a clean spring molding process resulting from dry molding tools, simple handling resulting from dry, coated preliminary products, favourable storage capability, cost-effective molding tools, better utilisation of the molding tools, increased production rates and comprehensive protection of the products manufactured in this manner against mechanical, chemical and weather-related factors.

In addition to manufacturing spring products, the invention is likewise applicable to the manufacture of other products of any given size, cross-section and type.

These and additional characteristics described in the patent claims, the description of possible embodiments and the drawings may each for themselves or in combination be realized as advantageous embodiments of the invention for which protection is being claimed here.

The invention will explained in more detail below based on the example of two embodiments. The associated drawings illustrate:

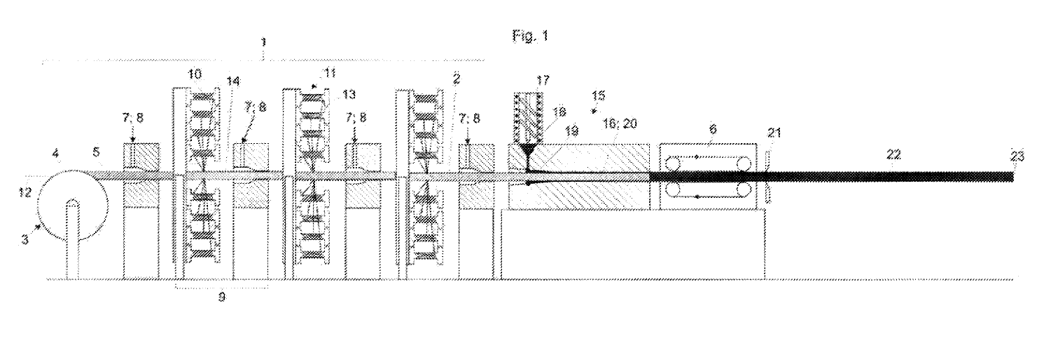

FIG. 1 a simplified representation of the first section of a device embodying the invention for manufacturing a spring based on the example the first embodiment,

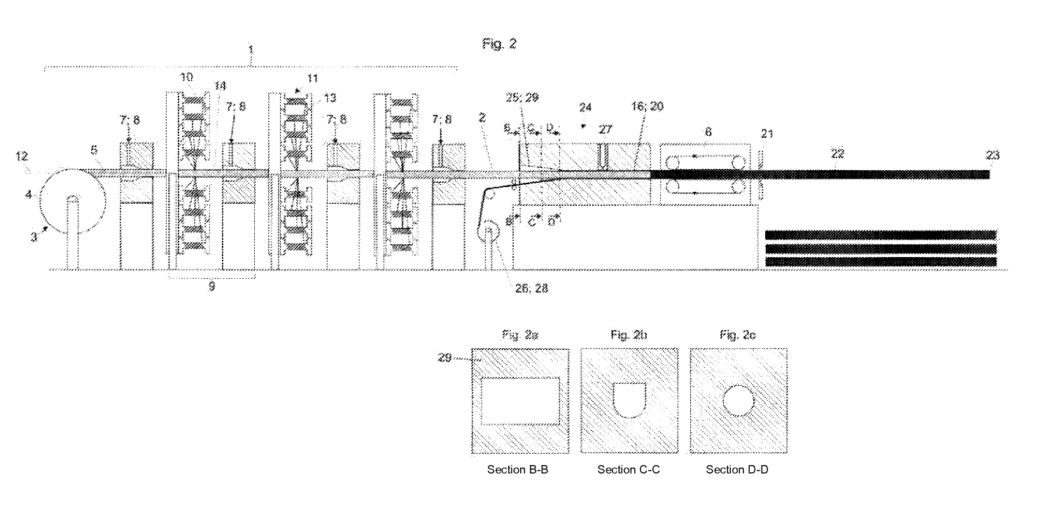

FIG. 2, 2a-c a simplified representation of the first section of a device embodying the invention for manufacturing a spring based on the example the second embodiment,

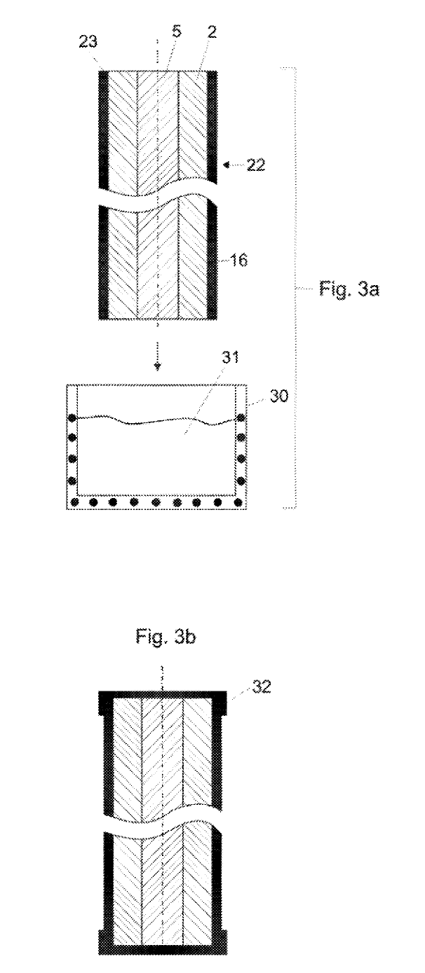

FIG. 3a a simplified sectional representation of a second section of the device embodying the invention,

FIG. 3b a sectional representation of a preliminary product with protective caps, manufactured based on FIG. 3a,

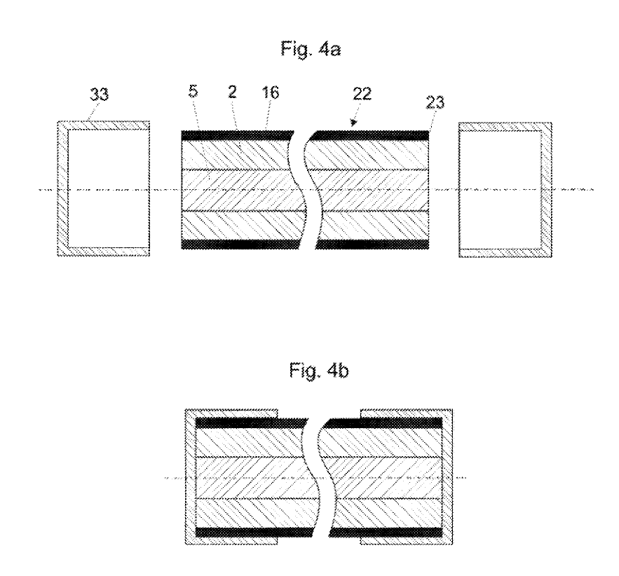

FIG. 4a an exploded view sectional representation of a preliminary product with prefabricated protective caps,

FIG. 4b a sectional representation of the preliminary product, manufactured based on FIG. 4a,

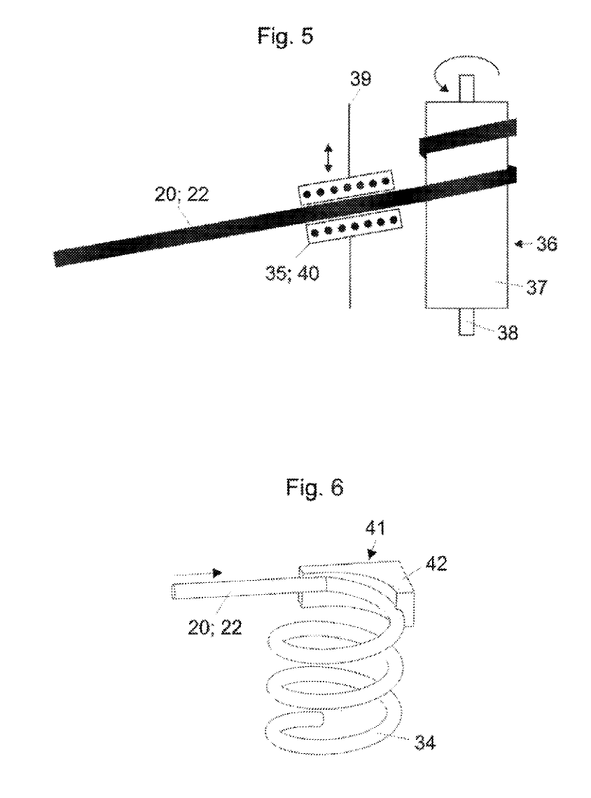

FIG. 5 a simplified representation of a third section of the device with a molding tool with winding core,

FIG. 6 a simplified representation of an alternative molding tool with a form element for free-form winding,

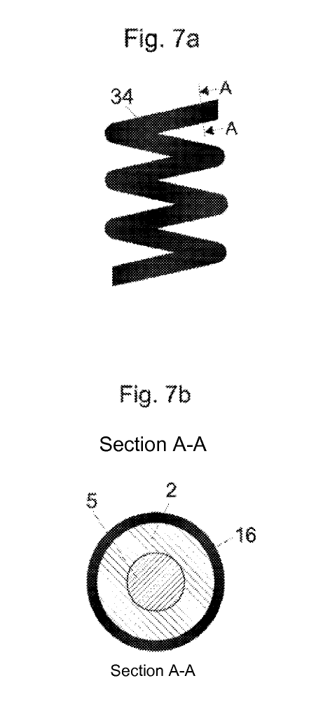

FIG. 7a a lateral view of a spring manufactured in accordance with the invention, and

FIG. 7b a lateral view of the spring based on FIG. 7a.

FIG. 1 illustrates the first section of a device in accordance with the invention for the manufacture of a spring 34 of fiber composite material based on the first example embodiment.

The first section of the device comprises a wet winding device 1 as processing unit 1 for the manufacture of an impregnated fiber strand (laminate strand) 2, an application unit 15 for creating a protective coat 16, a conveyor unit 6 for feeding the laminate strand 2 and a cutting device.

The processing unit 1 for the manufacture of an impregnated fiber strand 2 comprises a trigger unit 3 with a supply role 4 which is outfitted with a flexible, strand-shaped spring core or core element 5 which is continuously fed from the supply role 4 by the conveyor unit 6. In the illustrative embodiment, the strand-shaped spring core 5 is made of plastic and is characterised by a round cross section.

The flexible spring core 5 fed as described above is wet with a matrix material 8 via an initial impregnation system 7.

Thereafter, multiple processing stations 9 are arranged in series which each comprise a coiling machine 11 and an impregnation system 7 for purposes of impregnating fibers 10 with matrix material 8. Each respective coiling machine 11 may rotate on its axis 12 and is characterised by a number of bobbins 13 placed concentrically around the axis 12 from which the respective wound fibers or strands 10, respectively, are unwound.

Using this wet winding device 1, the fibers 10 are wound around the flexible strand-shaped spring core 5 to create a fiber strand 14 and are impregnated at the same time, whereby the impregnated laminate strand 2 is molded into a fiber preform.

The invention provides that the application unit 15 used in connection with the invention, in which the impregnated, wet laminate strand 2 is covered with a protective coat 16, is downstream from the wet winding device 1 in the direction of travel.

Pursuant to this first embodiment, the application unit 15 comprises an extruder 17 to extrude a molten mass 18 of plastic and a molding matrix 19 that encloses the laminate strand 2 which casts the molten mass 18 completely around the laminate strand 2.

By means of the conveyor unit 6, which continuously draws the laminate strand 2 through the extruder 17 with the molding matrix 19, a protective coat 16 of plastic in a defined thickness is created in a continuous application process that completely encloses the laminate strand 2.

If, as provided for in the example embodiment, a thermoplastic plastic is applied, this results in the creation of a malleable, dimensionally stable protective coat 16 made of thermoplastic.

If, for example, rubber or an elastomer are applied in this manner, this results in, in particular, an elastic protective coat 16 encompassing the flexible laminate strand 2.

The protective coat 16 prevents, in an advantageous manner, that during subsequent processing steps the impregnation material 8 drips and runs following application, whereby stoppage for cleaning due to soiling of device components in subsequent processing steps, in particular the subsequent molding tools 36, 41, is avoided.

After application of the plastic to the laminate strand 2 and cooling of the same, the strand-shaped preliminary product 20, including protective coat 16, is complete and is then withdrawn with the conveyor unit 6 and, in a cutting unit 21, cut into strand sections of a defined length 22 with their respective ends 23.

The ends 23 are thereafter enclosed with protective caps 32, 33 that are not depicted here, whereby strand sections 22 enclosed on all sides are formed which are particularly well-suited to further processing as readily storable and easy to handle preliminary products 20.

In a second example embodiment depicted in FIG. 2, the first section of the device in accordance with the invention features an alternate application unit 24 for manufacturing the spring 34.

In order to avoid repetition, only the characteristics and components differing from the first section of the device depicted in FIG. 1 will be described below.

The same components with the same function have the same reference number.

The application unit 24 depicted in FIG. 2 comprises, in accordance with the embodiment depicted in FIG. 1, a molding unit 25 for molding a strip material 26 and a joining device 27 for sealing the strip material 26.

The strip material 26, for example Aluminum thin sheets, is supplied on a roll 28 in a width corresponding to the size of the laminate strand 2. By means of a feeder, the strip material 26, together with the laminate strand 2, is drawn through a molding matrix 29 that encompasses the laminate strand 2. As part of this process, the strip material 26 is continuously molded corresponding to the constantly changing cross-sectional shape of the molding matrix 29 (depicted in FIGS. 2a to 2c), and is molded around the laminate strand 2 along its length until the longitudinal edges of the strip material 26 touch and enclose the circumference of the laminate strand 2.

The longitudinal edges of the strip material 26 meeting in this manner are joined along their entire length by an attached joining device 27. Pursuant to the example embodiment, the longitudinal edges are welded by means of laser welding unit 27.

The result is a tubular, malleable, dimensionally stable protective coat 16 made of thin aluminum sheets that completely seals the impregnated laminate strand 2.

The strand-shaped preliminary product 20 to which the protective coat 16 has been applied is, analogous to the first illustrative embodiment, withdrawn by means of the conveyor unit 6 and in the downstream cutting unit 21, cut into strand sections 22 of a defined length.

Alternatively to the application processes described above, other materials, tools and application steps may be provided for that are suited to create a protective coat 16 that completely encompasses the laminate strand 2 along its entire axis.

The preliminary products cut into strand sections 22 to which the protective coat 16 made of thermoplastic according to the first illustrative embodiment or the protective coat 16 made of thin Aluminum sheets according to second illustrative embodiment, respectively, have been applied are, in a second section of the device according to the invention in FIGS. 3a, 3b and 4a, 4b, sealed on their ends 23.

FIG. 3a depicts a sealing unit with a plunge basin 30 which contains a molten mass 31, for example, of plastic. The ends 23 of the strand sections 23 are dipped into the molten mass 31, whereby the liquid plastic coats the respective ends 23 and forms protective caps 32 after curing as depicted in FIG. 3b.

According to the depictions in FIGS. 4a and 4b, preformed protective caps 33, which may be made of plastic or metal for example, are attached to the ends 23 via an alternative sealing method.

Protective caps 32, 33 created via immersion or which are preformed create a drip-proof seal on the cut surfaces of the respective strand sections 22 of the preliminary product 20. Sealing creates entirely sealed, strand-shaped preliminary products 20 for efficient further processing, storage or shipment for the manufacture of finished springs.

FIGS. 5 and 6 each depict a third section of the device in accordance with the invention for the production of the spring 34, which may be set up separately from the first and second section of the device.

The third section shown in FIG. 5 depicts a molding tool 36 corresponding to the first illustrative embodiment that serves to mold the preliminary product 20 with a thermoplastic protective coat which was produced pursuant to the first illustrative embodiment depicted in FIG. 1. The molding tool 36 has an attached guide 35 in order to precisely feed the preliminary product 20.

The molding tool 36 is characterised by a smooth-walled, in this case cylindrical winding core 37 which is mounted such that it may be turned on its axis 38 and contains resources in order to affix the ends 23 of the preliminary product 20 with a thermoplastic protective coat 16.

The guide element 35 is, in relation to the molding tool 36, movable vertically along an axis 39 of the guide element.

The guide element 35 is characterised by a heatable intake 40. The thermoplastic protective coat 16 of the preliminary product 20 is rendered moldable by the application of heat in order to be able to mold the preliminary product 20 into the spring geometry in light of the flexibility gained in this manner.

In accordance with the helical shape to be created, the guide element 35 is, relative to the position of the rotating molding tool 36, moved vertically, whereby the pitch of the spiral coil is determined by feeding the preliminary product through the guide element 35.

By rotating the winding core 37 along the axis 38, as well as the vertical movement of the guide element 35 along the axis 39, the heated preliminary product is molded around the winding core 37 creating a spring 34 with a defined spring shape.

After the spring 34 has cooled, the thermoplastic protective coat 16 is once again dimensionally stable and may thus be removed from the winding core 37 prior to consolidation.

FIG. 6 depicts an alternative molding tool 41 according to the second illustrative embodiment that serves as the preferred method for molding the preliminary product 20 with a metal protective coat 16 produced in accordance with the second illustrative embodiment according to FIG. 2. The molding tool 41 comprises a molding element 42 for free-form molding by means of which the preliminary product 20, with a malleable, metallic protective coat 16, may be directly shaped into the spring geometry via cold forming. The preliminary product 20 is pressed against the molding tool 42 through the application of the corresponding amount of force, in this case in a prescribed quarter spiral groove, whereby the preliminary product 20 is molded into the prescribed spiral form by the molding element 42 corresponding to the geometry and size of the spring 34.

FIGS. 7a and 7b depict a spring 34 with a round cross-section that was manufactured based on a preliminary product 20 produced by one of the processes described above and the associated device with a thermoplastic protective coat.

The representation in FIG. 7a depicts a lateral view of the molded spring 34 after it was slightly removed from the smooth-walled winding core 37.

Several of these springs 34 may be collected for purposes of consolidation together in a curing unit not depicted here.

FIG. 7b depicts the molded spring 34 according to FIG. 7a cut-out (A-A) such that the round cross-section of the spring core 5, the fiber strand 14 surrounding the spring core 5 and the thermoplastic protective coat 16 are visible.

After the spring 34 has cured, the plastic spring core 5, if needed, may be removed via an investment casting process for example.

This results in a hollow section spring made of fiber composite material with a protective coat 16 not depicted here.

Similarly, after the spring 34 has cured, the protective coat 16 may be removed if needed or in the interest of light-weight construction, for example by mechanical means or melting through the application of heat.

If the protective coat 16 is left on the spring 34, it may alternatively serve protect the spring 34 from mechanical or chemical stresses, in particular protection against chipping or external weather factors.

### REFERENCE NUMBER INDEX

1 Processing device
2 Laminate strand, impregnated fiber layer
3 Extraction unit
4 Supply role
5 Spring core, core element
6 Conveyor unit
7 Impregnation system
8 Matrix material, impregnation material
9 Processing station
10 Fiber
11 Coiling machine
12 Axis
13 Bobbin
14 Fiber strand
15 Application unit
16 Protective coat
17 Extruder
18 Molten mass
19 Molding matrix
20 Preliminary product
21 Cutting device
22 Strand section
23 End of the strand section
24 Application unit
25 Molding tool
26 Strip material
27 Joining device, laser welding device
28 Role
29 Molding matrix
30 Plunge basin
31 Molten mass
32 Protective cap, immersed
33 Protective cap, preformed
34 Spring
35 Guide element
36 Molding tool
37 Cylindrical winding core
38 Axis
39 Axis
40 Heated intake
41 Molding tool
42 Molding element

1.-23. (canceled)

24. A process for producing a spring made of fiber composite material, wherein the process comprises molding a laminate strand formed by fibers of the fiber composite material and impregnated with a matrix material capable of consolidation into a spring geometry, and forming, prior to molding the laminate strand, a strand-shaped preliminary product by applying a malleable protective coat enclosing the laminate strand in a continuous application process.

25. The process of claim 24, wherein the protective coat is formed by extruding a molten mass of plastic, metal or metal alloy and continuously applying the molten mass around the laminate strand.

26. The process of claim 25, wherein the plastic is a thermoplastic or a wax.

27. The process of claim 25, wherein the molten mass is a molten metal alloy with a low melting point.

28. The process of claim 24, wherein the protective coat is formed by continuously applying and sealing a strip material of plastic, metal or metal alloy around the laminate strand.

29. The process of claim 28, wherein the strip material is made of thin sheets of aluminum, steel or titanium.

30. The process of claim 24, wherein the strand-shaped preliminary product is cut into strand sections at a defined length and ends of the strand sections are sealed.

31. The process of claim 30, wherein the ends of the strand sections are each dipped into a molten mass to form a respective protective cap.

32. The process of claim 30, wherein the ends of the strand sections are each sealed by a preformed protective cap.

33. The process of claim 24, wherein the protective coat and/or protective caps of strand sections cut from the preliminary product remain a component of the spring after molding of the preliminary product and consolidation of the matrix material.

34. The process of claim 24, wherein the protective coat and/or protective caps of strand sections cut from the preliminary product are removed from the spring after molding of the preliminary product and consolidation of the matrix material.

35. The process of claim 24, wherein the laminate strand is formed on a strand-shaped, malleable core element.

36. The process of claim 35, wherein the strand-shaped, malleable core element is made of a thermoplastic plastic, titanium or aluminum.

37. A device for the manufacture of a spring of a fiber composite material, wherein the device comprises a processing unit for producing a laminate strand formed of fibers and impregnated with a matrix material capable of consolidation followed, in a direction of travel of the laminate strand, by an application unit for forming a protective coat around the laminate strand.

38. The device of claim 37, wherein the application unit comprises an extruder with a molding matrix encompassing the laminate strand for continuous output and application of molten mass or comprising a molding unit with a molding matrix encompassing the laminate strand for continuous application of a strip material and a joining element for continuously sealing the strip material.

39. The device of claim 37, wherein the device further comprises a cutting unit for forming strand sections of a strand-shaped preliminary product, which cutting unit follows the application unit in a direction of travel of the laminate strand.

40. The device of claim 39, wherein the device further comprises a sealing unit for sealing ends of strand sections.

41. The device of claim 37, wherein the device further comprises, for molding a strand-shaped preliminary product into a spring geometry, a molding tool having a smooth-walled winding core which is associated with a guide element, or comprises a molding tool having a molding element for free-form molding.

42. A spring of fiber composite material, wherein the spring comprises a strand-shaped core element molded in a spring geometry of the spring, a fiber layer of fiber composite material encompassing the core element, and a protective coat encompassing the fiber layer, ends of the spring having protective caps, or wherein the spring comprises an elongated hollow section strand formed of a fiber layer of fiber composite material and molded into a spring geometry of the spring and a protective coat encompassing the hollow section strand, ends of the spring having protective caps.

43. The spring of claim 42, wherein the protective coat, the strand-shaped core element, the hollow section strand and/or the protective caps consist of plastic, metal or metal alloy.
